(19) United States
(12) Patent Application Publication
(10) Pub. No.: US 2021/0285771 A1
(43) Pub. Date: Sep. 16, 2021

(54) METHOD FOR EVALUATING SHALLOW WATER INFLUENCE

(71) Applicant: SCHOTTEL GMBH, D-56322 SPAY/RHEIN (DE)

(72) Inventor: Paul Mertes, Roes (DE)

(73) Assignee: SCHOTTEL GMBH, D-56322 SPAY/RHEIN (DE)

(21) Appl. No.: 17/264,032

(22) PCT Filed: Jul. 18, 2019
(86) PCT No.: PCT/EP2019/069341

§ 371 Date: Jan. 28, 2021

(30) Foreign Application Priority Data
Jul. 31, 2018 (DE) 10 2018 118 496.4

(51) Int. Cl. G01C 21/20; B63B 79/40

(52) U.S. Cl. CPC G01C 21/203; B63B 79/40

(57) ABSTRACT

A method for evaluating a shallow water influence on a motor vessel driven by a drive output, including the continuous sequence of steps: determination of the water depth adjacent to the motor vessel and of a set-point speed in deep water that is expected from the predetermined drive output; calculation of the expected speed loss from the set-point speed as a function of the determined water depth; determination of the necessary output difference in the drive output that is needed in order to compensate for the expected speed loss; and display of the expected speed loss and the necessary output difference on a display unit.

### BACKGROUND OF THE INVENTION

### Field of the Invention

This invention relates to a method for evaluating shallow water influence on a motor vessel driven with a drive output.

### Discussion of Related Art

In conventional shipping, the skipper determines the intended route of a motor vessel and specifies the output of the installed drive system. The output of drive or propulsion systems is specified by selecting the propeller speed and/or propeller pitch. In this connection, the skipper is responsible for correctly assessing the operating conditions such as water depth, water current conditions, wind pressure, and local traffic volume and for appropriately adjusting the output of the propulsion systems as a function of the scheduled destination arrival.

Navigation in canals, rivers, and shallow waters are all embraced by the umbrella term “limited fairway.” The person skilled in the art speaks of shallow waters when the fairway is limited in the vertical direction, such as beneath the hull. In addition, the lateral limitation of the fairway as in rivers or canals is often simultaneously accompanied by a limitation of the fairway toward the bottom.

As a result of these limitations, the drag on a motor vessel increases significantly. The causes for this are in the backflows that occur, the blockade effect, and a more powerful wave formation.

German Patent Reference DE 10 2008 032 394 A1 discloses regulating the set-point vessel speed as a function of the underwater topography.

Illies: Handbook of Marine Engineering [Handbuch der Schiffsbetriebstechnik], 2^{nd} edition, Vieweg, Braunschweig 1984, p. 358 f. ISBN 3-528-18249-0 and HARVALD: Resistance and Propulsion of Ships, John Wiley & Sons 1983, pp. 76-81, ISBN 0-471-06353-3 describe the Schlichting & Lackenby calculation model for determining the speed loss in shallow water.

A lack of experience on the part of the skipper and/or imprecise data result in an uncontrolled operation of the motor vessel. Such an uncontrolled operation in a limited fairway wastes energy and produces additional emissions without being reflected in an actually faster operation.

### SUMMARY OF THE INVENTION

One object of this invention is to provide a method for evaluating shallow water influence on a motor vessel driven with a drive output, which even with a less-qualified skipper, to propose an efficient conversion of the available drive output into propulsion of the motor vessel while largely eliminating the shallow water influence.

In order to attain the stated object, this invention uses a method according to the features, including advantageous embodiments and modifications of this invention as described in this specification and in the claims.

This invention provides the continuous sequence of the steps listed below in order to evaluate and display the shallow water influence, for example in the context of an assistance system installed in the motor vessel, or in order to enable the most efficient operation possible in the context of an automated control of the drive and/or rudder systems: including determination of the water depth adjacent to the motor vessel and of a set-point speed in deep water that is expected from the predetermined drive output; calculation of the expected speed loss from the set-point speed as a function of the determined water depth; determination of the necessary output difference in the drive output that is needed in order to compensate for the expected speed loss; and display of the expected speed loss and the necessary output difference on a display unit.

The expected set-point speed in deep water determined in step A is known, for example, from the vessel-specific propulsion characteristic curve based on the output demand of the motor vessel with a predetermined draft for a particular speed in deep water.

The quantification of the shallow water influence and expected speed loss as a function of the determined water depth depends decisively on the speed and underwater design of the motor vessel and on the topography and composition of the bed of the body of water.

According to one embodiment of the method according to this invention, the so-called linear wave theory can be used in order to assess whether shallow water conditions are present for a motor vessel with a given draft T and speed Vₛ on a body of water with a depth H. In general, several criteria can be checked in order to classify the water depth conditions into the categories “deep water,” “transition range,” and “shallow water.” Preferably, the following criteria are queried in order to determine the presence of shallow water:
Relationship between the water depth H and wave length λ:
   Shallow water is present if H/λ< 1/25
Relationship between the water depth H and speed Vₛ of the motor vessel over the Froude depth number Fₙₕ [inertial force/gravitational force=(speed of the vessel/speed of the gravitational waves)]
   Shallow water is present if Fₙₕ=Vₛ/(g*H)^{1/2}>x, where x=0.7
Relationship between the speed of the motor vessel and the water depth over the angle of the bow wave. In deep water, at speeds of up to a Froude number Fₙ<0.49 [=Vₛ/(g*L_{wt})^{1/2}=Fₙₕ] (with L_{wt}=length of the motor vessel at the water line), a fixed angle of the bow wave forms. In this connection, half of the opening angle of the bow wave is referred to as the Kelvin angle:
   Shallow water is present if the Kelvin angle>19.34°
Relationship between the draft T, water depth H, and speed of the vessel Vₛ
   Shallow water is present if 2.5<H/T<11
   Extremely shallow water with H/T<2.5 must be considered separately.

The relationship of the draft T to the water depth H, however, is not meaningful enough to identify shallow water. The shallow water influence can, however, be precisely isolated in connection with the Froude depth number Fₙₕ.
From the vessel-specific propulsion characteristic curve, the output demand of the motor vessel with a specific draft for a particular speed in deep water is already known. In comparison to this, based on the output demand detected during travel for example by corresponding sensors, it is possible to determine whether shallow water conditions are present. If the measured output demand, taking into consideration a measurement precision under otherwise equivalent conditions (for example trim, draft, wind, area exposed to wind, and current), is greater than the prediction, then it must be assumed that a significant shallow water influence is present.

### DETAILED DESCRIPTION OF THE INVENTION

In addition to a theoretical consideration, it is also possible to detect the change in the operating parameters during continuous operation in order to determine the presence of the shallow water influence. This detection can be used to train the system in accordance with the “machine learning” principle and to produce a specific prediction model.

In this respect, the method according to this invention is based on using the above-explained criteria or a combination thereof to continuously determine whether any shallow water conditions are present.

If this is the case, then for example the Schlichting & Lackenby method for determining the Froude depth number is used to calculate the expected speed loss from the set-point speed as a function of the determined water depth.

In this connection, in order to achieve maximum precision, the expected speed loss can be calculated for every ratio of water depth to draft. In many inland waterway vessel applications, however, a draft change does not turn out to be so great that even with a single curve, a sufficient degree of precision is achieved. Three drafts that lie a significant distance apart yield a bandwidth or a family of curves.

For the currently existing speed, the expected speed loss from the set-point speed calculated in the preceding step can then be used to determine the necessary output difference in the drive output that would be required in order to compensate for the expected speed loss.

In the simplest case, the expected speed loss determined in this way and the necessary output difference are then displayed on a suitable display unit, for example on the bridge of the motor vessel, and are thus brought to the skipper's attention. In one embodiment of this invention, a detailed display shows the skipper the achievable output change depending on the speed change in the form of a prediction over a range of speed changes.

Based on this display, the skipper, in coordination with the itinerary, shipping traffic, and the route, can decide whether, in order to increase efficiency, he wishes to reduce or increase the travel speed or whether the shallow water influence should be reduced by a course correction in order to increase the efficiency of the utilized drive output in relation to the achievable speed of the motor vessel.

According to one embodiment of this invention, a database can be provided in which the expected speed loss as a function of the expected set-point speed is stored for a predefinable number of water depths and drafts of the motor vessel and is read out and displayed as a calculation of the expected speed loss.

Such a database can, for example, be generated in a water current model or also by measurement trips of the specific vessel with different drafts, different speeds, and different intensities of shallow water influence.

The internal database can, for example, store fixed vessel-specific data such as the main dimensions of the vessel L_{WL}, B_{WL}, Lₒₐ, the main frame area, the design draft or preferably a vessel-specific hydrostatic table, a theoretical resistance or propulsion curve, and/or an engine map.

According to another embodiment of this invention, in order to calculate the expected speed loss, operation-specific data of the vessel are continuously determined and taken into account, including the current draft, water depth, water current speed, and vessel speed relative to the current. Optionally, the wave pattern in the form of a picture produced by a camera and corresponding image processing software can also be incorporated into the determination of the Kelvin angle.

The vessel-specific database that is established in this way can also be generated by theoretical calculations; alternatively, it is also possible to generate and continuously improve the database by a learning system.

According to another embodiment of this invention, the shallow water influence can be evaluated by calculating the ratio of the necessary output difference to the expected speed loss and comparing it to a predeterminable threshold so that when the result falls below the predeterminable threshold, the drive output of the motor vessel and/or its speed can be increased and when the result exceeds the predeterminable threshold, the increase of the drive output and/or speed is inhibited by permitting or hindering corresponding interventions in the control of the motor vessel.

In addition to the pure visualization of the necessary output difference and expected speed loss, it is also possible within the framework of this invention to establish an assistance system that is integrated into the automatic control and regulation of the motor vessel in terms of its drive output and/or its course.

In the simplest case, such a system performs an operating point optimization of the propulsion for defined ranges of water depths based on the existing input data and visualizes the potential for output optimization and the skipper selects the vessel speed that appears to be the most suitable.

It is also possible, however, for such a system to perform an operating point optimization of the propulsion for defined ranges of water depths based on the existing input data and for it to output this in the form of control commands to the propulsion systems. The speed of the motor vessel is thus automatically regulated and the necessary output difference is minimized.

Furthermore, with a known water current profile and water depth profile, the system can determine the best position in the navigation channel, for example based on correspondingly provided electronic charts of the segment currently being navigated, so that the absolute speed over ground is maximized, such as the expected speed loss is minimized, or a speed profile with a minimized necessary output difference over a predetermined course and a predetermined travel time is calculated, which is accompanied by a minimization of the pollutant emissions and/or fuel consumption.

In this respect, such a system offers a proactive control of the vessel speed as a function of the scheduled destination arrival and the operating conditions such as water depth, current, wind pressure, etc. in individual route segments of the overall course. It automatically ensures the optimization of the propeller speed and vessel speed taking into account the desired travel time and the existing water depths. Based on the predetermination of the course and the desired arrival time, it is possible to determine the required vessel speed. The existing information from the input values is evaluated based on the speed influence and a speed profile for the course can be automatically planned. The planning of the speed profile can be continuously updated at predetermined time intervals.

In addition, the traffic conditions or route conditions can also be incorporated into the calculation. Filling levels of the fuel tank can additionally be calculated in the system, which generates an automatic residual force projection.

The input values used in the context of the method according to this invention include the current water depth and the draft, which are detected by a suitable sensor system aboard the motor vessel and reported to a corresponding assistance system that carries out the method. Optionally, a camera with evaluation software can display the wave pattern and can determine the Kelvin angle and likewise report it to the assistance system.

The drive system detects the current output data by sensors and reports it. The output data can be detected by various parameters depending on the sensor system that is installed in the motor vessel. This output data of the current operating state and the prevailing fuel consumption are input into the assistance system.

The electronic navigation system, for example ECDIS, can be used to input a chart display with the position data of a satellite navigation system and information from radar data and sounding data. This indicates the route information such as the length of the predetermined course, speed limits, and water depths, which are provided to the assistance system.

The vessel speed is detected by onboard instruments and the present speed is reported to the assistance system.

The propeller speed, possibly the propeller pitch in the case of an adjustable propeller, and the steering angle can likewise be determined by corresponding sensors and are reported to the assistance system.

If they are not already stored in the electronic navigation system, it is possible for position and speed information from a satellite navigation to be provided.

Optionally, it is also possible for information about individual route segments to be retrieved from external databases and provided to the assistance system. Examples include the traffic volume, the current water depth under current profile, hazards such as disasters, and local weather data such as wind, wind direction, visibilities, and environmental zones.

In addition, there is the vessel-specific information stored in the provided databases, for example theoretical propeller characteristic curves (thrust, output over engine speed) with various drafts; wind resistance and current resistance of the motor vessel; main dimensions of the motor vessel or preferably the vessel-specific hydrostatic table; theoretical resistance or propulsion curve, and optionally an engine map.

With the above-described method, the skipper can be provided with an assistance system, which detects and reports the negative influences of limited fairways and optimizes the propulsion output within predetermined limits in order to establish a particularly economical operation. In this connection, the prior experience-based criteria can be taken into account, but new measurable values can also be incorporated into the evaluation.

For a predetermined travel route, the energy consumption for individual route segments is calculated taking into account any shallow water conditions that may be present there and an operation profile is planned. Depending on the configuration level, such an assistance system can also activate the propulsion automatically.

Such automation makes sense particularly in the inland waterway vessel sector with less-qualified persons on board who are not easily able to operate the vessel economically.

The above-explained method according to this invention can, for example, be stored in the form of a computer program in a computer unit aboard the vessel. The computer unit that is programmed in this way can either be integrated into the automation system of the motor vessel that is present anyway or can be provided as a separate unit and can communicate with the automation system.

1. A method for evaluating a shallow water influence on a motor vessel driven by a drive output, comprising the continuous sequence of steps:
a) determining a water depth adjacent to the motor vessel and a set-point speed in deep water that is expected from a predetermined drive output;
b) calculating an expected speed loss from the set-point speed as a function of a determined water depth;
c) determining a necessary output difference in the drive output that is needed to compensate for the expected speed loss; and
d) displaying an expected speed loss and a necessary output difference on a display unit.

2. The method according to claim 1, wherein a database is provided in which the expected speed loss as a function of the expected set-point speed is stored for a predeterminable number of water depths and drafts of the motor vessel and is read out and displayed as a calculation of the expected speed loss.

3. The method according to claim 1, wherein in order to calculate the expected speed loss, operation-specific data of the vessel are continuously determined and taken into account, including the current draft, the water depth, the water current speed, and the vessel speed relative to the current.

4. The method according to f claim 3, wherein the set-point speed in deep water expected from the predetermined drive output is determined based on a propulsion curve of the motor vessel stored in a database.

5. The method according to claim 1, wherein in order to calculate the expected speed loss as a function of the determined water depth according to step b), a Froude depth number of the motor vessel, a relationship between the water depth and a wave length determined at a bow of the motor vessel, an angle of a bow wave of the motor vessel, and/or a relationship between the draft and water depth of the motor vessel is determined.

6. The method according to claim 5, wherein the ratio of the necessary output difference to the expected speed loss is calculated and compared to a predeterminable threshold and when a result falls below the predeterminable threshold, the drive output of the motor vessel and/or its speed can be increased and when the result exceeds the predeterminable threshold, the increase of the drive output and/or speed is inhibited.

7. The method according to claim 6, wherein the speed of the motor vessel is automatically controlled as a function of the water depth and the necessary output difference is minimized.

8. The method according to claim 7, wherein the position of the motor vessel is determined, water current profiles and water depth profiles from a provided electronic chart are input and a course of the motor vessel is calculated in which the expected speed loss is minimized or a speed profile with a minimized necessary output difference over a predetermined course and a predetermined travel time is calculated.

9. The method according to claim 1, wherein the set-point speed in deep water expected from the predetermined drive output is determined based on a propulsion curve of the motor vessel stored in a database.

10. The method according to claim 4, wherein in order to calculate the expected speed loss as a function of the determined water depth according to step b), a Froude depth number of the motor vessel, a relationship between the water depth and a wave length determined at a bow of the motor vessel, an angle of a bow wave of the motor vessel, and/or a relationship between the draft and water depth of the motor vessel is determined.

11. The method according to claim 1, wherein the ratio of the necessary output difference to the expected speed loss is calculated and compared to a predeterminable threshold and when a result falls below the predeterminable threshold, the drive output of the motor vessel and/or its speed can be increased and when the result exceeds the predeterminable threshold, the increase of the drive output and/or speed is inhibited.

12. The method according to claim 1, wherein the speed of the motor vessel is automatically controlled as a function of the water depth and the necessary output difference is minimized.

13. The method according to claim 1, wherein the position of the motor vessel is determined, water current profiles and water depth profiles from a provided electronic chart are input and a course of the motor vessel is calculated in which the expected speed loss is minimized or a speed profile with a minimized necessary output difference over a predetermined course and a predetermined travel time is calculated.
